(19) United States
(12) Patent Application Publication
(10) Pub. No.: US 2011/0074639 A1
(43) Pub. Date: Mar. 31, 2011

(54) DEVICE HOUSING

(75) Inventors: ZHI-GUO ZHAO, Shenzhen City (CN); YONG-FA FAN, Shenzhen City (CN); JIE ZENG, Shenzhen City (CN); YONG YAN, Shenzhen City (CN); ZHAN LI, Santa Clara, CA (US)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/813,601

(22) Filed: Jun. 11, 2010

(30) Foreign Application Priority Data
Sep. 25, 2009 (CN) 200910307699.5

(51) Int. Cl. H01Q 1/24

(52) U.S. Cl. 343/702

(57) ABSTRACT

A device housing comprises a main body and a three-dimensional antenna. The main body defines an antenna region thereon. The three-dimensional antenna is a conductive ink coating and is formed on the antenna region of the main body.

### BACKGROUND

1. Technical Field

The present disclosure relates to device housings, especially to a device housing having a three-dimensional antenna formed thereon.

2. Description of Related Art

Antennas are critical for wireless communication of electronic devices (such as mobile phones, computers, PDAs, and so on). The antenna may be a thin metal piece mounted to a support member, and attached to a device's housing. To save space, weight, and money, the antenna may be directly attached to the housing without the support member. However, the antenna, especially the antenna in three-dimensional form mounted without a support member is prone to damage during manufacturing. To solve this problem, a printable antenna is used by printing a conductive ink coating on the housing. However, the conductive ink can be difficult to print on the housing especially when trying to form a three-dimensional antenna, which may be preferred in some applications than two-dimensional antenna.

Therefore, there is room for improvement within the art.

### BRIEF DESCRIPTION OF THE FIGURES

Many aspects of the device housing can be better understood with reference to the following figures. The components in the figures are not necessarily drawn to scale, the emphasis instead being placed upon clearly illustrating the principles of the device housing. Moreover, in the drawings like reference numerals designate corresponding parts throughout the several views.

FIG. 1 is a schematic view of an exemplary embodiment of a device housing.

FIG. 2 is an exploded view of an exemplary embodiment of the device housing shown in FIG. 1.

### DETAILED DESCRIPTION

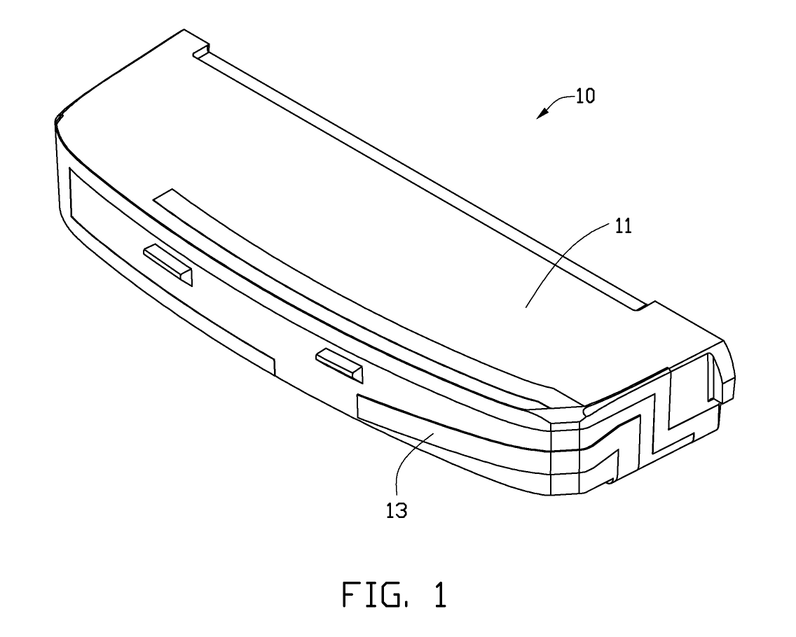

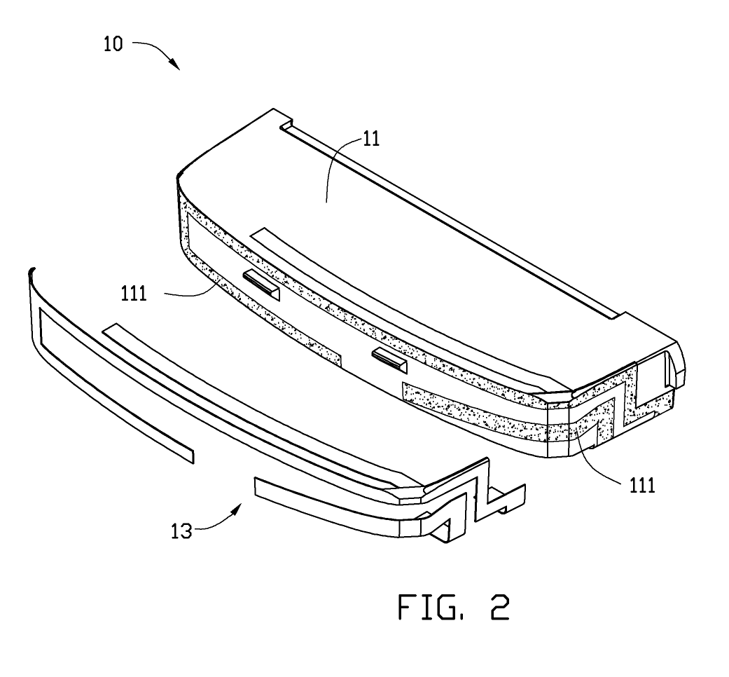

FIG. 1 and FIG. 2 show a device housing 10 including a main body 11 and a three-dimensional antenna 13 formed on the main body 11.

The main body 11 may be molded of a moldable plastic. The moldable plastic may be one or more materials selected from a group consisting of polypropylene (PP), polyamide (PA), polycarbonate (PC), polyethylene terephthalate (PET), and polymethyl methacrylate (PMMA). The main body 11 may define an antenna region 111 on the exterior surface. The antenna region 111 has substantially the same shape as the three-dimensional antenna 13.

The three-dimensional antenna 13 may be a conductive ink coating deposited by pad printing using a pad printing machine. The three-dimensional antenna 13 may have a thickness of about 8-10 μm, and has a resistivity of no more than about 0.005Ω/μm².

The pad printing machine may include a plurality of silicone pads and a printing plate. The printing plate defines an etched area corresponding to the three-dimensional antenna 13. The etched area is filled with conductive ink. During printing, the silicone pads of the pad printing machine are pressed down onto the printing plate to transfer the conductive ink from the etched area onto the silicone pads. The silicone pads are pressed down onto the antenna region 111 of the main body 11 forming the three-dimensional antenna 13. After printing, the main body 11 is heated in an oven to solidify the three-dimensional antenna 13.

The conductive ink for the three-dimensional antenna 13 contains a conductive component, such as silver powder, copper powder, or a mixture of the silver powder and copper powder. The conductive ink may further contain hardening agents and additives. The additives may contain pigment and surface adjusting agents.

The exemplary pad printed three-dimensional antenna 13 can be easily produced in large numbers compared to the metal three-dimensional antennas. Furthermore, the exemplary three-dimensional antenna 13 can be designed in many suitable shapes according to frequencies to be used.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A device housing, comprising:
a main body, the main body defining an antenna region thereon; and
a three-dimensional antenna, the three-dimensional antenna being a conductive ink coating formed on the antenna region of the main body.

2. The device housing as claimed in claim 1, wherein the three-dimensional antenna has a thickness of about 8-10 μm.

3. The device housing as claimed in claim 1, wherein the conductive ink coating contains silver powder, copper powder, or a mixture of silver powder and copper powder.

4. The device housing as claimed in claim 3, wherein the conductive ink coating further contains hardening agents and additives.

5. The device housing as claimed in claim 1, wherein the three-dimensional antenna has a resistivity of no more than about 0.005Ω/μm².

6. The device housing as claimed in claim 3, wherein the main body is molded with plastics being one or more materials selected from a group consisting of polypropylene, polyamide, polycarbonate, polyethylene terephthalate, and polymethyl methacrylate.

7. A device housing, comprising:
a main body; and
a three-dimensional antenna, the three-dimensional antenna being a conductive ink coating formed on the main body by pad printing.
